(19) United States
(12) Patent Application Publication
(10) Pub. No.: US 2011/0192033 A1
(43) Pub. Date: Aug. 11, 2011

(54) CABLE STRIPPING TOOL AND METHOD OF STRIPPING CABLE

(75) Inventor: Robert L. Kasprzycki, Cazenovia, NY (US)

(73) Assignee: John Mezzalingua Associates, Inc.

(21) Appl. No.: 12/703,824

(22) Filed: Feb. 11, 2010

(51) Int. Cl. H02G 1/12

(52) U.S. Cl. 30/91.2; 29/825

(57) ABSTRACT

A cable stripping tool including a tool body and an operating module that is selectively: a) placed in an operative position upon the tool body; and b) separated as a unit from the tool body. The operating module has a stop with a surface and at least one cutting blade. The operating module is reconfigurable between: a) a first state wherein a cable can be placed in a cutting position with an end of the cable bearing upon the stop surface; and b) a second state wherein the at least one cutting blade penetrates a cable in the cutting position to a predetermined depth. The tool body is reconfigurable to change the operating module in the operative position between the first and second states.

### BACKGROUND OF THE INVENTION

1. Field of the Invention

This invention relates to stripping tools for cable and, more particularly, to a stripping tool that can be reconfigured to facilitate stripping of cable in different manners.

2. Background Art

There is a multitude of portable, cable stripping tools currently available. Common to most of these tools is at least one blade that is caused to penetrate a wire layer to a predetermined depth, whereupon the tool and wire can be relatively turned to sever the entire circumference of the layer to the penetrated depth. A severed layer portion can then be separated to expose a layer or a component thereunder. The tool may incorporate a stop to which an end of the cable is abutted to allow penetration at consistent distances from the cable end.

One exemplary cable construction is a coaxial cable. Typical of coaxial cable is a construction wherein a conductive core is surrounded by a conductive layer/outer conductor that is in the form of a foil or braided material. An insulating layer resides between the core and outer conductor, which in turn is surrounded by a nonconductive sheath.

To prepare the coaxial cable end for connection, commonly a multi-bladed tool is employed. One blade is arranged to penetrate the cable to the core at one lengthwise location, with the other blade arranged to penetrate the sheath to the outer conductor at a second lengthwise location. By then turning the tool around the core axis, the cable components can be severed continuously around the cable axis, thereby permitting severed components to be separated from the cable end. This strategically exposes a predetermined length of the core and outer conductor to facilitate assembly of an appropriate fitting or connector on the prepared cable end.

The same basic construction for the tool is utilized to allow stripping of other cables, such as one with only a single conductor at the core.

In certain industries, such as the cable industry, technicians will be required to prepare different cables to be electrically connected to a wide range of components. For example, 50 ohm wireless connectors currently come in seven different dimensions, each requiring different manners of cable preparation. Manufacturers often offer different configurations of cable end connectors that demand still other manners of cable preparation. It is anticipated that further variations of connector will evolve, demanding yet additional capabilities to prepare cable ends.

Technicians on any particular site may encounter many different cable types and connector configurations. He/she must have tools on hand at any given site to allow the appropriate cable preparation that permits a consistent and effective electrical union with the various connectors.

Commonly, as in the case of wireless connectors, a technician will keep on hand a selection of stripping tools corresponding in number to the connector variations. As noted above, currently that number is seven. While such tools are relatively inexpensive, in quantities of seven for each technician, the costs grow to be beyond negligible.

From the standpoint of the technician, it is also burdensome to have to transport, and keep readily available, the full complement of stripping tools that may be required. While each such stripping tool can be relatively compact in nature, an exemplary collection of seven such tools takes up significant, valuable space in a box or bag that a technician may transport from site to site with such tools and other tools and components used for a particular job run.

In one such tool construction, a tool body is provided with a fixed stop surface, whereby the tool body is configured to strip cable in only a single manner. While tools of this type have been configured to releasably accept a blade cartridge, the design is such that the cartridges are replaced only to remedy a situation where the existing blade is worn or broken and not to change the manner in which the tool cuts a particular cable.

Certain tools have been devised in the industry that make it possible for a single tool to cut cable in different manners for stripping. For example, it is known to replace or reconfigure one component on a stripping tool that cooperates with another, common component on the same stripping tool. By so doing, there is a risk that the replaced or reconfigured part will not cooperate as desired with the common component. As an example, cuts made with the reconfigured stripping tool may end up in wrong locations and potentially at inappropriate depths. For this and other reasons, to the knowledge of the inventor herein, none of these designs has been developed to be practically usable on a commercial level.

In many industries, such as the communications industry, in which cables must be prepared for connection, there is a tremendous amount of competition that pares profit margin significantly. In striving for the highest efficiency, companies balance a number of competing activities. Saving money by controlling investment in tooling may cause situations where a technician is not equipped to handle a site condition, thereby potentially necessitating a costly return trip. Alternatively, improvised procedures may be utilized that compromise the integrity of connections. Generally, burdening a technician with a multitude of tools may take away from his/her efficiency in a given day.

In spite of the above, well known problems, the industry continues to employ stripping tools that are deficient in one or more of the above respects. That is because viable alternatives are not commercially available.

### SUMMARY OF THE INVENTION

In one form, the invention is directed to a cable stripping tool including a tool body and an operating module that is selectively: a) placed in an operative position upon the tool body; and b) separated as a unit from the tool body. The operating module has a stop with a surface and at least one cutting blade. The operating module is reconfigurable between: a) a first state wherein a cable can be placed in a cutting position with an end of the cable bearing upon the stop surface; and b) a second state wherein the at least one cutting blade penetrates a cable in the cutting position to a predetermined depth. The tool body is reconfigurable to change the operating module in the operative position between the first and second states.

In one form, the operating module has a first component upon which the stop surface is provided and a second component upon which the at least one cutting blade is provided. A connector joins the first and second components and allows the first and second components to be moved relative to each other, thereby to change the operating module between the first and second states.

In one form, the connector is in the form of a living hinge that flexes to allow the first and second components to be moved relative to each other.

In one form, the tool body includes first and second jaws. The first component is connected to the first jaw and the second component is connected to the second jaw. The tool body is reconfigurable by causing the first and second jaws to be relatively moved, as an incident of which the operating module in the operative position is changed between the first and second states.

The first and second jaws may be guided in pivoting movement relative to each other about a first axis.

In one form, the tool body is reconfigurable between: a) a mounting state; and b) an operating state. With the tool body in the mounting state and the operating module in the operative position, the first and second components are biasably captive between the first and second jaws.

In one form, the first jaw and first component are relatively configured so that the first component can be moved in a path relative to the first jaw into a seated position, and as an incident thereof keyed against movement relative to the first jaw in a direction transverse to the path.

In one form, the second jaw and second component are relatively configured so that the second component can be moved in a path relative to the second jaw into a seated position, and as an incident thereof keyed against movement relative to the second jaw in a direction transverse to the path.

In one form, the operating module is a first operating module that in an operative position allows the at least one cutting blade to penetrate a cable in the cutting position in a first manner. A second operating module includes a second stop surface and at least a second cutting blade. The second operating module is selectively: a) placed in an operative position upon the tool body in place of the first operating module; and b) separated as a unit from the tool body. The second operating module is reconfigurable between first and second states corresponding to the first and second states for the first operating module. With the second operating module in its operative position, the at least second cutting blade is allowed to penetrate a cable in the cutting position in a second manner that is different than the first manner.

In one form, the invention is provided in combination with a cable in the cutting position.

In one form, the invention is directed to an operating module for use with a tool body to strip cable. The operating module includes a first component on which a stop surface is provided and a second component upon which at least one cutting blade is provided. A connector joins the first and second components into a unitary module and allows the first and second components to be moved relative to each other to allow the operating module to be changed between first and second states. With the operating module in the first state, a cable can be placed in a cutting position with an end of the cable bearing upon the stop surface. With the operating module in the second state the at least one cutting blade penetrates a cable in the cutting position to a predetermined depth. The operating module is configured to be placed in an operative position upon a tool body that can be reconfigured to change the operating module between the first and second states.

In one form, the connector is in the form of a living hinge.

In one form, with the operating module in the second state, the first and second components are biased away from each other.

In one form, the first component is configured to be press fit to a tool body by movement in a path into a seated position, wherein the first component is keyed against movement relative to the tool body in a direction transverse to the path.

In one form, the second component is configured to be press fit to a tool body by movement in a path into a seated position, wherein the second component is keyed against movement relative to the tool body in a direction transverse to the path.

In one form, the first component has an elongate rib that is configured to be keyed with respect to a complementary shape on a tool body.

In one form, the second component has an elongate rib that is configured to be keyed with respect to a complementary shape on a tool body.

The invention is further directed to a method of stripping cable. The method includes the steps of providing a tool body and a first operating module that is selectively: a) placed in an operative position upon the tool body; and b) separated as a unit from the tool body. The first operating module includes a first stop surface and at least one cutting blade. A second operating module is provided that is selectively: a) placed in an operative position upon the tool body; and b) separated as a unit from the tool body. The second operating module includes a second stop surface and at least a second cutting blade. The first operating module is placed in its operative position upon the tool body. A first cable is placed in a cutting position, wherein an end of the first cable bears against the first surface. The first operating module is reconfigurable through the tool body to cause the at least one cutting blade to penetrate the first cable in a first manner. The at least one cutting blade and first cable are relatively moved to separate by cutting a part of the first cable.

The first operating module is separated from the tool body. The second operating module is placed in its operative position upon the tool body in place of the first operating module. A second cable is placed in a cutting position, wherein an end of the second cable bears against the second surface. The second operating module is reconfigured through the tool body to cause the at least second cutting blade to penetrate the second cable in a second manner that is different than the first manner. The at least second cutting blade and second cable are relatively moved to separate by cutting a part of the second cable.

In one form, the step of providing a first operating module involves providing a first operating module with a first component upon which the first stop surface is provided, a second component upon which the at least one cutting blade is provided, and a connector that joins the first and second components and allows the first and second components to be moved relative to each other.

In one form the step of providing a first operating module involves providing a first operating module with a connector that is in the form of a living hinge.

### BRIEF DESCRIPTION OF THE DRAWINGS

FIG. 1 is a perspective view of a cable stripping tool, according to the present invention, and consisting of a tool body and an operating module, with the operating module in an operative position thereupon;

FIG. 2 is a view as in FIG. 1 with the operating module separated from the tool body and in a first state;

FIG. 3 is a cross-sectional view of a first component on the operating module and with a length of cable in a cutting position thereon;

FIG. 4 is a fragmentary, elevation view of the operating module in a second state;

FIG. 5 is a fragmentary, elevation view of the first component on the operating module being directed into a seated position upon the tool body; and

FIG. 6 is a schematic representation of another operating module that can be used with the tool body in FIGS. 1 and 2.

### DETAILED DESCRIPTION OF THE PREFERRED EMBODIMENTS

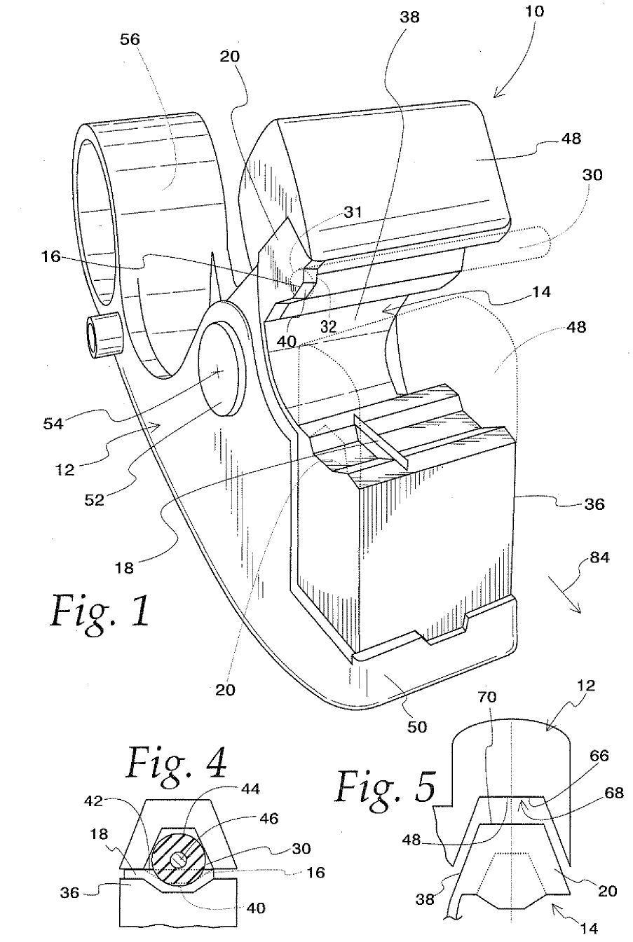

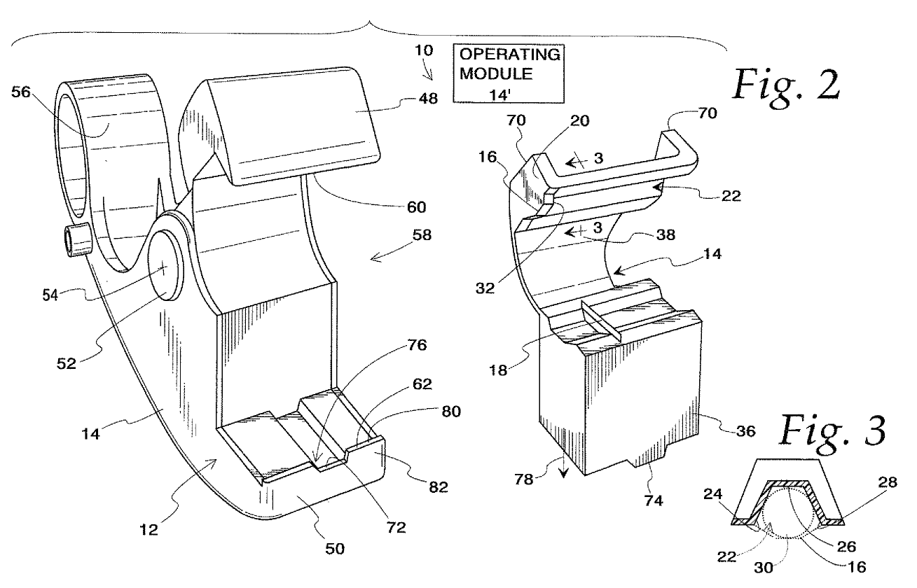

Referring initially to FIGS. 1-5, a specific form of cable stripping tool, according to the present invention, is shown at 10. The cable stripping tool 10 consists of a tool body 12 and an operating module 14 that is selectively: a) placed in an operative position upon the tool body 12, as shown in FIG. 1; and b) separated as a unit from the tool body 12, as shown in FIG. 2.

The operating module 14 has a stop 16, and in this embodiment, one cutting blade 18. The operating module 14 has a first component 20 upon which the stop 16 is provided. The first component 20 defines a wire receptacle 22 that has an inverted “U” shape bounded cooperatively by angled, flat surface portions 24, 26, 28. A cable 30 can be placed in the receptacle 22 and shifted lengthwise so that an end 31 thereof abuts a surface 32 on the stop 16, thereby to consistently maintain the cable end 31 in lengthwise relationship to the cutting blade 18 on a second component 36 on the operating module 14.

A connector 38 joins the first and second components 20,36 and allows the first and second components 20, 36 to be moved relative to each other, thereby to change the state of the operating module 14.

More particularly, the operating module 14 is reconfigurable between: a) a first state, as shown in solid lines in FIG. 1, wherein the cable 30 can be placed in a cutting position, as also shown in FIG. 1, wherein the cable end 31 bears upon the stop surface 32; and b) a second state, as shown in dotted lines in FIG. 1 and solid lines in FIG. 4, wherein the cutting blade 18 penetrates the cable 30 to a predetermined depth. The predetermined depth is predictably maintained by reason of the abutment of a surface 40 on the stop 16 to a facing surface 42 on the second component 36. In FIG. 4, the cutting blade 18 is shown penetrating a non-conductive sheath 44 on the cable 30 up to the outer perimeter of a core conductor 46. As explained in greater detail below, the invention is not limited to use with any specific cable type, as it is contemplated that the cable stripping tool 10 could be configured to perform virtually any stripping operation upon many different cables.

In this embodiment, the connector 38 is in the form of a living hinge. For example, the connector 38 may be made from material such as plastic or metal, that normally biases the first and second components 20, 36 to their orientation as shown in FIG. 2, but that permits relative movement between the first and second components to the FIG. 4 state. With the living hinge construction, the connector 38 flexes to allow the above-described, required relative movement between the first and second components 20, 36 to change the operating module 14 between its first and second states.

The tool body 12 is reconfigurable to change the state of the operating module 14. The tool body 12 has a first jaw 48, to which the first component 20 is connected. The tool body 12 has a second jaw 50, to which the second component 36 is connected. The first and second jaws 48,50 are joined through a shaft 52 for relative pivoting movement about the shaft axis 54. Through relative pivoting movement between the jaws 48, 50, the tool body 12 is reconfigurable between a mounting state, as shown in solid lines in FIG. 1 and FIG. 2, and an operating state, represented in FIG. 1 with the first jaw 48 shown in dotted lines in relationship to the second jaw 50. As an incident of changing the tool body 12 from its mounting state into its operating state, the operating module 14 is changed from its first state into its second state, represented respectively in FIGS. 2 and 4.

The tool 10 can be operated by captively engaging the first and second jaws 48, 50 and exerting a squeezing force thereupon to relatively move the jaws 48, 50 around the axis 54. This could be accomplished through a compressive action between the user's fingers and thumb. Alternatively the second jaw 50 might be nested in the user's palm, whereupon the first jaw 48 can be repositioned through the user's thumb and/or fingers.

The tool body 12 has an integral finger ring 56 which may accept the user's index finger. With the jaws 48, 50 squeezed so as to place the operating module in the second state, a user's finger directed through the finger ring 56 can be used to produce a turning action upon the tool 10 that causes the cutting blade 18 to continuously sever the cable 30 about its perimeter to the predetermined depth.

The tool body 12 and operating module 14 are relatively configured so that the operating module 14 can be changed from a separated position in FIG. 2 into the operative position of FIG. 1 through a press fitting step, without requiring separate fasteners. The invention does contemplate that separate fasteners could be employed, if desired.

More particularly, the jaws 48, 50 are initially placed in the mounting state of FIGS. 1 and 2. The first and second components 20, 36 are then urged towards each other against a bias force produced by the connector 38 sufficiently to reduce the dimension of the operating module 14 to allow the operating module 14 to be directed through an opening 58 between edges 60, 62 on the first and second jaws 48, 50, respectively. By then releasing the compressive force between components 20, 36, the components 20, 36 move away from each other against the jaws 48, 50 and thereby become biasably captive between the jaws 48, 50. Residual forces in the connector 38 cause the components 20, 36 to bias the jaws 48, 50 so as to thereby place and maintain the tool body 12 in the mounting state.

As shown in FIG. 5, as the operating module 14 is being placed in the operative position upon the tool body 12, and the compressive force upon the components 20, 36 is released, the first component 20 is biased by residual forces in the connector 38 in a path indicated by the arrow 64 relative to the first jaw 48 against a seat 66 bounding a receptacle 68 for the first component 20. The first component 20 has an outer surface 70 in the form of a rib that is complementary in shape to the seat 66 so that the first component 20 is keyed against movement relative to the first jaw 48 in a direction transverse to the path as indicated by the arrow 64.

The second component 36 is biased similarly into a seat 72 on the second jaw 50. The outer surface 74 of the second component 36 is in the form of a rib that is complementary to the seat 72 that defines a receptacle 76 for the outer surface 74. During assembly of the operating module 14, upon the user's releasing of the compressive force between the components 20, 36, the second component 36 is caused to move in a path, indicated by the arrow 78, to cause the outer surface 74 to be biased into the seat 72. The complementary contours of the seat 72 and outer surface 74 cause the second component 36 to be keyed against movement relative to the second jaw 50 in a direction transverse to the path indicated by the arrow 78.

A surface 80 upon a ledge 82 on the second jaw 50 prevents separation of the second component 36 from the second jaw 50 by movement relative thereto in the direction of the arrow 84.

Accordingly, with the first and second components 20, 36 in seated positions relative to the first and second jaws 48, 50, as shown in FIG. 1, the press fit operating module 14 is locked in place and remains biasably captive in a consistent position and orientation between the first and second jaws 48, 50. To effect separation of the operating module 14, the assembly steps are reversed. That is, the components 20, 36 are urged towards each other to compact the configuration of the operating module 14 sufficiently that it can be passed through the opening 58.

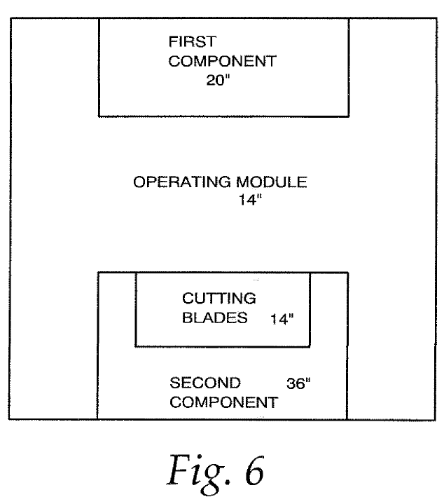

As shown in FIG. 2, the invention contemplates a kit-type arrangement wherein a separate operating module 14′ can be provided in combination with the generic tool body 12 and operating module 14. The operating modules 14, 14′ are interchangeably assembled to the tool body 12, one in place of the other, for operation. The operating module 14′ may have the same configuration as the operating module 14 or, more preferably, has a different configuration to cause a cable in the cutting position to be penetrated for cable preparation in a manner different than occurs with the operating module 14. This may be by reason of a different cutting depth, a different spacing between the stop surface 30 and cutting blade, and/or by reason of there being one or more additional cutting blades, as shown for an operating module 14″ in FIG. 6, having corresponding first and second components 20″, 36″.

By reason of using self-contained operating modules, the cooperation of the components thereon is predetermined. This assures consistent and predictable placement of cuts and reliable overall tool operation with each operating module selected.

An exemplary method of stripping cable, using the inventive tool, is as follows. A tool body 12 and first and second operating modules 14, 14′ are provided. The first operating module 14 is placed in an operative position upon the tool body 12. A first cable 30 is placed in a cutting position wherein the end 31 thereon bears against the stop surface 32. The first operating module 14 is reconfigured through the tool body 12 to cause the cutting blade 18 to penetrate the cable 30 in a first manner. The cutting blade 18 and cable 30 are relatively moved to separate by cutting a part of the cable 30. The first operating module 14 is separated from the tool body 12 and replaced by the second operating module 14′. The stripping process, described above with respect to the cable 30, is repeated for another length of cable utilizing the second operating module 14′ to cause at least one cutting blade thereon to penetrate the cable in a second manner that is different than the first manner.

The foregoing disclosure of specific embodiments is intended to be illustrative of the broad concepts comprehended by the invention.

1. A cable stripping tool comprising:
a tool body; and
an operating module that is selectively: a) placed in an operative position upon the tool body; and b) separated as a unit from the tool body,
the operating module comprising a stop with a surface and at least one cutting blade,
the operating module reconfigurable between: a) a first state wherein a cable can be placed in a cutting position with an end of the cable bearing upon the stop surface; and b) a second state wherein the at least one cutting blade penetrates a cable in the cutting position to a predetermined depth,
the tool body reconfigurable to change the operating module in the operative position between the first and second states.

2. The cable stripping tool according to claim 1 wherein the operating module comprises a first component upon which the stop surface is provided, a second component upon which the at least one cutting blade is provided, and a connector that joins the first and second components and allows the first and second components to be moved relative to each other thereby to change the operating module between the first and second states.

3. The cable stripping tool according to claim 2 wherein the connector comprises a living hinge that flexes to allow the first and second components to be moved relative to each other.

4. The cable stripping tool according to claim 2 wherein the tool body comprises first and second jaws, the first component is connected to the first jaw, the second component is connected to the second jaw and the tool body is reconfigurable by causing the first and second jaws to be relatively moved as an incident of which the operating module in the operative position is changed between the first and second states.

5. The coaxial cable stripping tool according to claim 4 wherein the first and second jaws are guided in pivoting movement relative to each other about a first axis.

6. The cable stripping tool according to claim 4 wherein the tool body is reconfigurable between: a) a mounting state and b) an operating state, with the tool body in the mounting state and the operating module in the operative position, the first and second components are biasably captive between the first and second jaws.

7. The cable stripping tool according to claim 4 wherein the first jaw and first component are relatively configured so that the first component can be moved in a path relative to the first jaw into a seated position and as an incident thereof keyed against movement relative to the first jaw in a direction transverse to the path.

8. The cable stripping tool according to claim 4 wherein the second jaw and second component are relatively configured so that the second component can be moved in a path relative to the second jaw into a seated position and as an incident thereof keyed against movement relative to the second jaw in a direction transverse to the path.

9. The cable stripping tool according to claim 1 wherein the operating module is a first operating module that in an operative position allows the at least one cutting blade to penetrate a cable in the cutting position in a first manner and further in combination with a second operating module, the second operating module comprising a second stop surface and at least a second cutting blade, the second operating module selectively: a) placed in an operative position upon the tool body in place of the first operating module; and b) separable as a unit from the tool body, the second operating module reconfigurable between first and second states corresponding to the first and second states for the first operating module, and with the second operating module in its operative position the at least second cutting blade is allowed to penetrate a cable in the cutting position in a second manner that is different than the first manner.

10. The cable stripping tool according to claim 1 in combination with a cable in the cutting position.

11. An operating module for use with a tool body to strip cable, the operating module comprising:
a first component on which a stop surface is provided;
a second component upon which at least one cutting blade is provided; and
a connector that joins the first and second components into a unitary module and allows the first and second components to be moved relative to each other to allow the operating module to be changed between first and second states,
with the operating module in the first state, a cable can be placed in a cutting position with an end of the cable bearing upon the stop surface,
with the operating module in the second state the at least one cutting blade penetrates a cable in the cutting position to a predetermined depth,
the operating module configured to be placed in an operative position upon a tool body that can be reconfigured to change the operating module between the first and second states.

12. The operating module according to claim 11 wherein the connector comprises a living hinge.

13. The operating module according to claim 11 wherein with the operating module in the second state, the first and second components are biased away from each other.

14. The operating module according to claim 11 wherein the first component is configured to be press fit to a tool body by movement in a path into a seated position wherein the first component is keyed against movement relative to the tool body in a direction transverse to the path.

15. The operating module according to claim 11 wherein the second component is configured to be press fit to a tool body by movement in a path into a seated position wherein the second component is keyed against movement relative to the tool body in a direction transverse to the path.

16. The operating module according to claim 14 wherein the first component has an elongate rib that is configured to be keyed with respect to a complementary shape on a tool body.

17. The operating module according to claim 15 wherein the second component has an elongate rib that is configured to be keyed with respect to a complementary shape on a tool body.

18. A method of stripping cable, the method comprising the steps of:
providing a tool body;
providing a first operating module that is selectively: a) placed in an operative position upon the tool body; and b) separable as a unit from the tool body,
the first operating module comprising a first stop surface and at least one cutting blade;
providing a second operating module that is selectively: a) placed in an operative position upon the tool body; and b) separable as a unit from the tool body,
the second operating module comprising a second stop surface and at least a second cutting blade;
placing the first operating module in its operative position upon the tool body,
placing a first cable in a cutting position wherein an end of the first cable bears against the first surface;
reconfiguring the first operating module through the tool body to cause the at least one cutting blade to penetrate the first cable in a first manner;
relatively moving the at least one cutting blade and first cable to separate by cutting a part of the first cable;
separating the first operating module from the tool body;
placing the second operating module in its operative position upon the tool body in place of the first operating module;
placing a second cable in a cutting position wherein an end of the second cable bears against the second surface;
reconfiguring the second operating module through the tool body to cause the at least second cutting blade to penetrate the second cable in a second manner that is different than the first manner; and
relatively moving the at least second cutting blade and second cable to separate by cutting a part of the second cable.

19. The method of stripping cable according to claim 18 wherein the step of providing a first operating module comprises providing a first operating module comprising a first component upon which the first stop surface is provided, a second component upon which the at least one cutting blade is provided, and a connector that joins the first and second components and allows the first and second components to be moved relative to each other.

20. The method of stripping cable according to claim 19 wherein the step of providing a first operating module comprises providing a first operating module with a connector that comprises a living hinge.
